(19) United States
(12) Patent Application Publication
(10) Pub. No.: US 2002/0082948 A1
(43) Pub. Date: Jun. 27, 2002

(54) Computed radiography configuration and selection method and apparatus

(76) Inventor: Edward J. Panelli, Chicago, IL (US)

Correspondence Address: Patrick S. Yoder, Suite 330, 7915 FM 1960 West, Houston, TX, 77070, US

(21) Appl. No.: 09/747,544

(22) Filed: Dec. 22, 2000

(51) Int. Cl. G06F 17/60

(52) U.S. Cl. 705/27; 705/10

(57) ABSTRACT

A system and method for providing a computed radiography (CR) system customer with a recommended CR system and/or CR system configuration. The recommended CR system being established by a customer's responses to a plurality of questions. The system has a product selector file and a product configuration file. The product selector file provides a query page with the plurality of questions to be answered by the customer. The product configuration file having a plurality of predicted system values. A Java applet being used to compare the customer's responses to the plurality of questions to the predicted values. The product configuration file supplying a results page with the recommended system.

### FIELD OF THE INVENTION

The present invention relates generally to the selection of a computed radiography (CR) system, and more particularly, to a method and apparatus for enabling a CR system supplier to provide a customer with a recommended CR system and information regarding the recommended CR system.

### BACKGROUND OF THE INVENTION

Historically, medical diagnostic images were recorded by exposing an imaging plate to a source of penetrating radiation. To view the image on the imaging plate, the imaging plate, or a recording of the image on the imaging plate, would have to be physically brought to the viewer. Many imaging systems now record images electronically, rather than by exposing an imaging plate. The imaging systems may be coupled to a digital imaging and archiving system so that the digital images recorded by the imaging systems may be transmitted electronically to remote locations for viewing.

However, many diagnostic imaging systems still record images in non-digital formats. Additionally, a medical facility may have a large inventory of archived film plates. A CR system enables an image on an imaging plate to be converted into a digital format. The CR system scans the imaging plate and converts the information into digital data that may then be transmitted over a digital imaging and archiving system to a workstation or viewing station for viewing and/or image manipulation.

To purchase a CR system, a customer may contact a supplier of CR systems to request information regarding the supplier's CR systems. Alternatively, a CR system supplier may contact a customer in hopes of generating sales of CR systems. Both parties in each of these cases may waste significant amounts of time attempting to elicit basic information from the other. For example, it may take a CR system supplier a significant amount of time to establish the customer's basic CR system needs or desires. Additionally, a customer may expend significant amounts of time obtaining basic information about the CR systems available from the supplier. Indeed, the customer may receive information from a CR system supplier about systems that are simply not suited to satisfy the customer's needs.

There is a need, therefore, for an improved technique for providing an CR system customer with purchasing information regarding a supplier's CR systems prior to contact between a sales representative of the supplier and the customer. There is a particular need for a system or method that provides a customer with information for a recommended CR system in response to a customer query designed to provide the supplier with some basic information about a customer's needs for a CR system.

### SUMMARY OF THE INVENTION

According to one aspect of the present invention, a system is featured to enable a computed radiography (CR) system supplier to provide a customer with a recommended CR system. The system has an application server that directs a query page to the customer via a network. The query page provides the customer with a plurality of questions. The plurality of questions are designed to enable the system to determine a recommended CR system for the customer based on the customer's responses to the questions. At least one of the questions is worded so that a customer's response to the question establishes whether a plate CR system or a multiple plate CR system is to be recommended to the customer. The system also has a comparison program. The comparison program receives a completed query page from the customer and compares the customer's responses in the completed query page to information stored in the computer system to determine the recommended CR system. The system also has a server to provide a results page to the customer via the network. The results page provides the customer with a recommended single plate or multiple plate CR system.

According to another aspect of the present invention, a computer system is featured that enables a customer to select a CR system from among a plurality of CR systems. The computer system has an application server that is coupled to a network. The application server directs a customer to files stored in the computer system. One file stored in the computer system is a product selector file written in a markup language. The product selector file holds a plurality of questions that are designed to obtain data from a customer so as to determine a single computed radiography system to recommend to the customer. Also, the product selector file provides the plurality of questions to a query page for delivery to a customer. The computer system also has a program that operates to determine a recommended CR system for the customer by comparing data provided by the customer via the plurality of questions to CR system data stored in the computer system. Another file stored in the computer system is a product configuration file written in a markup language. The product configuration file holds the CR system data used by the program. The product configuration file provides the recommended CR system to a results page for delivery to the customer.

According to another aspect of the present invention, a method is featured for utilizing a computer system to assist a customer to configure a CR system. The method comprises the act of routing a request for assistance from a customer to a product selector file written in extensible markup language (XML). The product selector file fills a template with questions stored in the product selector file. The method also comprises the acts of delivering the template over the network to a customer and receiving the completed template from the customer. The method also comprises the act of determining a recommended CR system configuration by comparing customer data derived from the completed template to supplier data stored in the computer system in a product configuration file. The product configuration file is also written in XML. The product configuration file fills a results page with the recommended CR system configuration for delivery to the customer over the network.

### BRIEF DESCRIPTION OF THE DRAWINGS

FIG. 1 is a diagrammatical representation of a picture archiving and communication system or PACS for receiving and storing image data in accordance with certain aspects of the present technique;

FIG. 2 is a diagrammatical representation of contents of a database for referencing stored image data in files containing multiple image data sets, compressed data, and descriptive information;

FIG. 3 is a representation of a typical image of the type received, compressed, and stored on the system of FIG. 1;

FIG. 4 is a diagrammatical representation of a computer system to enable a computed radiography (CR) system supplier provide a customer with a recommendation for a CR system;

FIG. 5 is a flowchart for a process whereby a CR system supplier may provide a customer with a recommendation for a CR system;

FIG. 6 is a representation of a page for a CR system supplier, the page having a link to a CR system product selector;

FIG. 7 is a representation of a query page for a CR system product selector;

FIG. 8 is a representation of a help page for a CR system product selector;

FIG. 9 is a representation of a results page featuring a recommended CR system; and

FIG. 10 is a representation of a results page when the system cannot provide a recommended CR system and directing the customer to contact a supplier's representative.

### DETAILED DESCRIPTION OF THE INVENTION

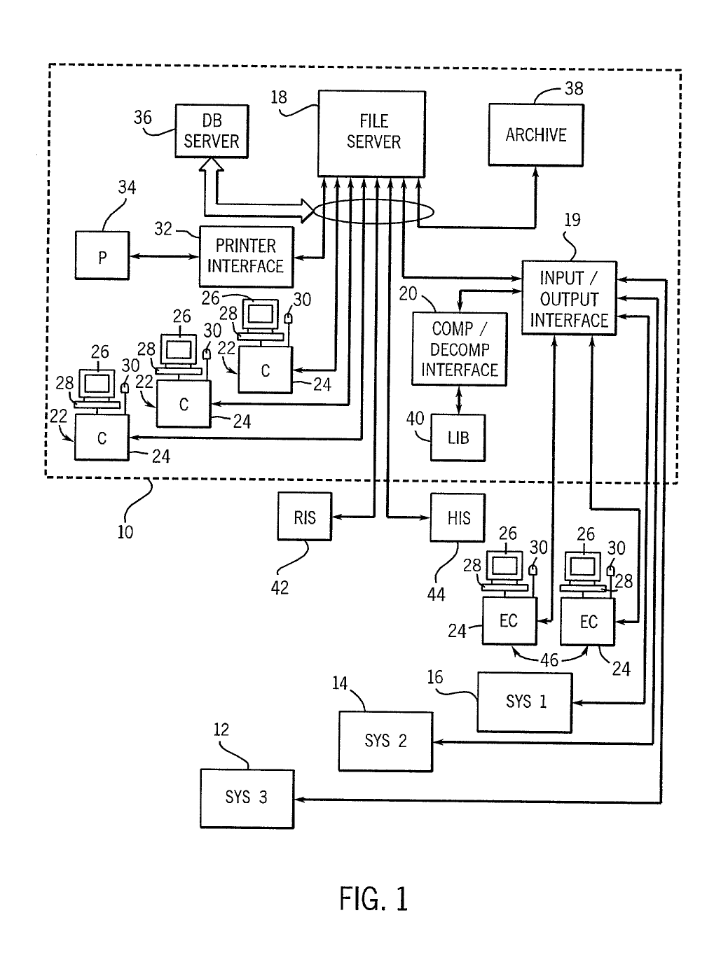

FIG. 1 illustrates a picture archive and communication system or PACS 10 for receiving, compressing and decompressing image data. In the illustrated embodiment, PACS 10 receives image data from several separate imaging systems designated by reference numerals 12, 14 and 16. As will be appreciated by those skilled in the art, the imaging systems may be of various type and modality, such as magnetic resonance imaging (MR) systems, computed tomography (CT) systems, positron emission tomography (PET) systems, radio fluoroscopy (RF), ultrasound systems, and so forth. Moreover, the systems may include computed radiography (CR) systems or other digitizing stations designed to provide digitized image data from existing film or hard copy images. It should also be noted that the systems supplying the image data to the PACS may be located locally with respect to the PACS, such as in the same institution or facility, or may be entirely remote from the PACS, such as in an outlying clinic or affiliated institution. In the latter case, the image data may be transmitted via any suitable network link, including open networks, proprietary networks, virtual private networks, and so forth.

PACS 10 includes one or more file servers 18 designed to receive and process image data, and to make the image data available for decompression and review. Server 18 receives the image data through an input/output interface 19. Image data may be compressed in routines accessed through a compression/decompression interface 20. As described more fully below, interface 20 serves to compress the incoming image data rapidly and optimally, while maintaining descriptive image data available for reference by server 18 and other components of the PACS. Where desired, interface 20 may also serve to decompress image data accessed through the server. The server is also coupled to internal clients, as indicated at reference numeral 22, each client typically including a radiological imaging workstation 24 at which a radiologist, physician, or clinician may access image data from the server, decompress the image data, and view or output the image data as desired. Client radiological imaging workstation 24 will typically include a computer monitor 26, a keyboard 28, as well as other input devices 30, such as a mouse. The imaging workstation 24 enables the client to view and manipulate data from a plurality of imaging systems, such as MRI systems, CT systems, PET systems, RF, and ultrasound systems.

Server 18 may be coupled to one or more interfaces, such as a printer interface 32 designed to access and decompress image data, and to output hard copy images via a printer 34 or other peripheral. Server 36 also may associate image data, and other work flow information within the PACS by reference to one or more file servers 18. Database server 36 may include cross-referenced information regarding specific image sequences, referring or diagnosing physician information, patient information, background information, work list cross-references, and so forth. The information within database server 36 serves to facilitate storage and association of the image data files with one another, and to allow requesting clients to rapidly and accurately access image data files stored within the system. Similarly, server 18 is coupled to one or more archives 38, such as an optical storage system, which serve as repositories of large volumes of image data for backup and archiving purposes. Techniques for transferring image data between server 18, and any memory associated with server 18 forming a short term storage system, and archive 38, may follow any suitable data management scheme, such as to archive image data following review and dictation by a radiologist, or after a sufficient time has lapsed since the receipt or review of the image files.

In the illustrated system, other components of the PACS system or institution may be integrated with the foregoing components to further enhance the system functionality. For example, as illustrated in FIG. 1, a compression/decompression library 40 is coupled to interface 20 and serves to store compression routines, algorithms, look up tables, and so forth, for access by interface 20 (or other system components) upon execution of compression and decompression routines (i.e. to store various routines, software versions, code tables, and so forth). In practice, interface 20 may be part of library 40. Library 40 may also be coupled to other components of the system, such as client stations 22 or printer interface 32, serving similarly as a library or store for the compression and decompression routines and algorithms. Although illustrated as a separate component in FIG. 1, it should be understood that library 40 may be included in any suitable server or memory device, including within server 18. Moreover, code defining the compression and decompression processes may be loaded directly into interface 20 and/or library 40, or may be loaded or updated via network links, including wide area networks, open networks, and so forth.

Additional systems may be linked to the PACS, such as directly to server 36, or through interfaces such as interface 19. In the embodiment illustrated in FIG. 1, a radiology department information system or RIS 42 is linked to server 18 to facilitate exchanges of data, typically cross-referencing data within database server 36, and a central or departmental information system or database. Similarly, a hospital information system or HIS 44 may be coupled to server 36 to similarly exchange database information, workflow information, and so forth. Where desired, such systems may be interfaced through data exchange software, or may be partially or fully integrated with the PACS system to provide access to data between the PACS database and radiology department or hospital databases, or to provide a single cross-referencing database. Similarly, external clients, as designated at reference numeral 46, may be interfaced with the PACS to enable images to be viewed at remote locations. Each external client also typically utilizes a radiological imaging workstation 24 at which a radiologist, physician, or clinician may access image data from the server, decompress the image data, and view or output the image data as desired. Such external clients 46 may employ decompression software, or may receive image files already decompressed by interface 20. Again, links to such external clients may be made through any suitable connection, such as wide area networks, virtual private networks, and so forth.

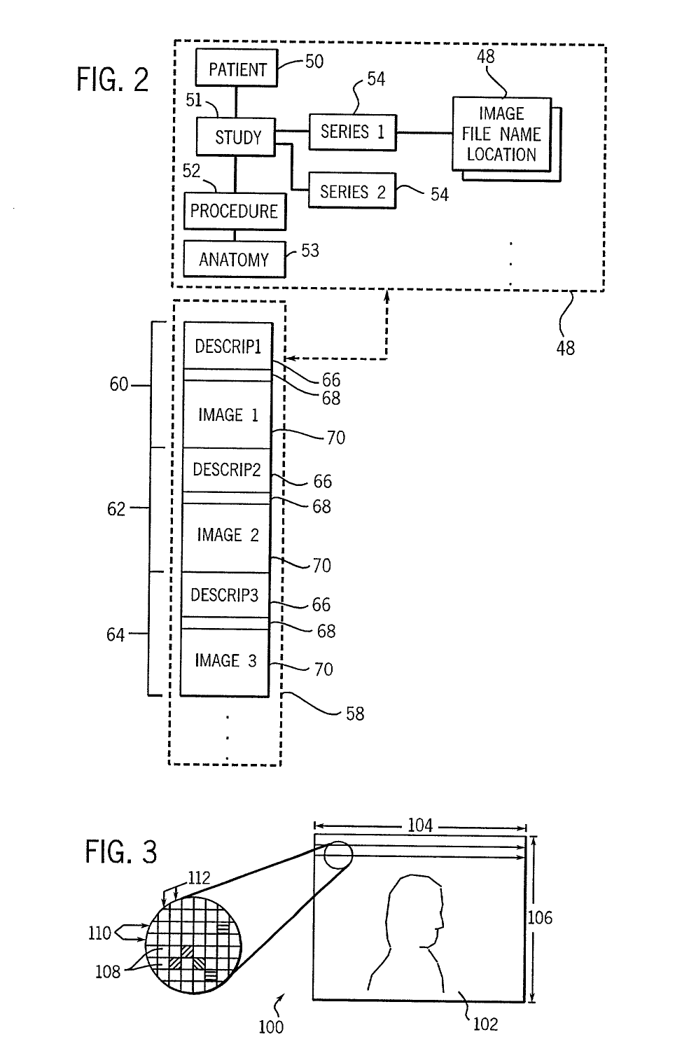

FIG. 2 illustrates in somewhat greater detail the type of cross-referencing data made available to clients through database server 36. The database entries, designated generally by reference numeral 48 in FIG. 2, will include cross-referenced information, including patient data 50, references to specific studies or examinations 51, references to specific procedures performed 52, references to anatomy imaged 53, and further references to specific image series 54 within the study or examination. Such cross-referenced information may include further information regarding the time and date of the examination and series, the name of diagnosing, referring, and other physicians, the hospital or department where the images are created, and so forth. The database will also include address information identifying specific images, file names, and locations of the images as indicated at reference numeral 56. Where the PACS includes various associated memory devices or short term storage systems, these locations may be cross-referenced within the database and may be essentially hidden from the end user, the image files simply being accessed by the system for viewing from the specific storage location based upon cross-referenced information in the database.

FIG. 2 also illustrates an exemplary image file cross-referenced by the database entries. As shown in FIG. 2, image file 58 includes a plurality of image data sets 60, 62 and 64. In a typical image file, a large number of such image sets may be defined by a continuous data stream. Each data set may be compressed in accordance with specific compression algorithms, including lossless compression algorithms, lossy compression algorithms, wavelet algorithms, and the preferred compression code table-based optimal compression algorithm described below.

Within each image data set, a descriptive header 66 is provided, along with a compression header 68. The headers 66 and 68 are followed by compressed image data 70. The descriptive header 66 of each data set preferably includes industry-standard or recognizable descriptive information, such as DICOM compliant descriptive data. Such descriptive information will typically include an identification of the patient, image, date of the study or series, modality of the system creating the image data, as well as additional information regarding specific anatomies or features visible in the reconstructed images.

FIG. 3 illustrates a typical image that is encoded by packets of digitized data assembled in a continuous data stream that may be created by a CR system, and compressed and decompressed. The image, designated generally by the reference numeral 100, will typically include features of interest 102, such as specific anatomical features. In medical diagnostic applications, such features may include specific anatomies or regions of a patient viewable by virtue of the physics of the image acquisition modality, such as soft tissue in MRI system images, bone in x-ray images, and so forth. Each image is comprised of a matrix having a width 104 and a height 106 defined by the number and distribution of individual pixels 108. The pixels of the image matrix are arranged in rows 110 and columns 112, and will have varying characteristics which, when viewed in the reconstructed image, define the features of interest. In a typical medical diagnostic application, these characteristics will include gray level intensity or color. In the digitized data stream, each pixel is represented by binary code, with the binary code being appended to the descriptive header to aid in identification of the image and in its association with other images of a study. As noted above, such descriptive information may include industry standard information, such as DICOM compliant data.

A CR system is used to scan the imaging plate for conversion into digital data. In a typical CR system, the CR system scans an exposed photostimulatable phosphor imaging plate and converts the information into 12 bit digital data. The CR system automatically transfers the image to a radiological imaging workstation for further processing and manipulation. A CR system may be either a single plate system or a multi-plate system. A single plate system consists of a single plate input. A multi-plate system features an input/output buffer system that enables the CR system to receive multiple imaging plates so that an operator does not have to process individual plates one at a time. The multi-plate CR system does not require any manual interaction other than placing the cassette in the input buffer of the CR system. Both the single plate and multi-plate systems have network connections for transmission of data to the radiological imaging workstation.

Various processing software packages may be used with a CR system. The processing software processes and displays CR images on a greyscale or color monitor. The processing software processes the raw CR images automatically. The processing software package may provide detailed contrast enhancement, unique collimation border detection, edge enhancement, latitude and noise reduction while producing an artifact free image. Other processing packages may provide inverted sensitometry, zoom, dynamic roam, collimation border setting and masking, modification or completion of non-protected patient data and information, horizontal and vertical flipping, rotating, mirroring, and WYSIWYG out to hardcopy.

The CR system may have a previewing station. The previewing station may have software packages to perform various functions. Identification software may be used to record patient demographics and examination information. An imaging plate may be disposed within a cassette. A memory chip may be disposed within the cassette. The identification software enables the patient data onto the memory chip. The identification software also links the demographic and image data set to the appropriate image processing parameters. The software may be integrated with other software to provide a link to an HIS/RIS.

Preview software displays the image on a monitor immediately after it is scanned and processed. This enables an operator to check the image for quality and patient positioning before sending the image for hardcopy generation or to the PACS for softcopy display.

Autorouting software automates image routing for increased productivity. Each examination type may be linked by a default to a destinations, such as a PACS, laser imager or display workstation.

DICOM storage software enables the CR system to transmit, store, and view CR images using the DICOM standard. DICOM is a standard that enables images and associated information to be transferred between various vender's equipment.

Black border software automatically identifies collimation borders having a certain film density and displays those areas as a black border around the diagnostic image. This automatic adjustment helps eliminate glare and ambient light interference when viewing diagnostic images. Information outside the image remains visible due to the translucent appearance of the black border.

Other software packages may be used for a variety of purposes. Dose monitoring software may be used for monitoring exposure errors. Annotation software may be used to annotate images on screen. Annotations may include markers, arrows, text, and geometrical images. Full-leg/Full-spine software may be used to assemble one composite image showing geometric continuity of body parts. Dental software may be used to provide a set of operating parameters that are unique to oral exposures. CR systems may also utilize uninterrupted power supplies, LAN kits and Routers kits.

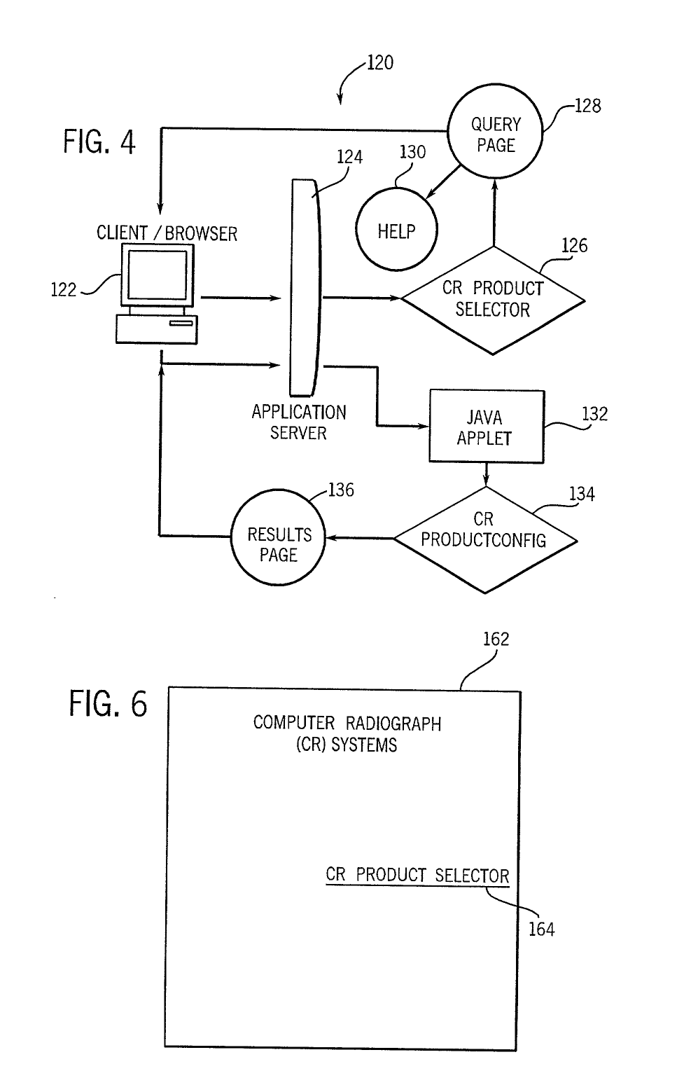

Referring generally to FIG. 4, a system 120 is illustrated that enables a CR system supplier to provide a customer with a recommended CR system. A CR system may be selected as a potential recommended CR system for a variety of reasons. For example, specific configurations of CR systems may be selected to represent recommended CR systems based on the sales history of that specific configuration of CR system, with the CR configurations having the highest sales representing recommended CR systems.

In the illustrated embodiment, a customer may use a computer 122, or other browsing device to access the system 120 over a network, such as the Internet. The system 120 utilizes an application server 124, a CR product selector file 126, a query page 128, a help page 130, a Java applet 132, a CR product configuration file 134 and a results page 136 to provide a customer with recommended CR system data. The application server 124 is used to route information around system 120. The application server may comprise a program, such as a Java class. The CR product selector file 126 holds the data that is used to populate the query page 128 to be supplied to the customer. The query page 128 contains at least one question designed to tailor the choice of possible CR systems, components or software to meet the needs of the customer. The help page 130 is linked to the query page 128 and contains additional information to assist a customer in answering at least one of the questions.

The Java applet 132 compares the answers in the completed query page 128 to data in the CR product configuration file 134. The CR product configuration file contains a set of data for a plurality of CR systems that correspond to predicted responses to the questions in the CR product selector file. All possible combinations of answers to the plurality of questions may be provided with an associated, or recommended, CR system. Alternatively, not all of the possible combinations may be provided with a corresponding, or recommended, CR system. This smaller set of combinations may be based on a number of factors. For example, the product configuration file 134 may be written so that a recommendation is made only for the most commonly sold configurations of CR systems. If the Java applet 132 finds a match between the customer's response and a predicted response, the CR system information corresponding to the predicted response is provided to the customer via the results page 136. If there is no match, an advisory to contact a sales representative may be provided to the customer.

In the illustrated embodiment, the CR product selector file 126 and the CR product configuration file 134 are XML files. XML is a method for putting structured data in a text file. XML is powerful because it maintains the separation of the user interface from structured data. HTML specifies how to display data in a browser, but XML defines the content. For example, in HTML tags are used to tell the browser to display data as bold or italic; in XML, style sheets are employed to present the data in a browser. XML separates the data from the presentation and processing, enabling data to be displayed and processed differently by applying different style sheets and applications.

As will be appreciated by those skilled in the art, XML is a meta-markup language that provides a format for describing structured data. This facilitates more precise declarations of content and more meaningful search results across multiple platforms. An unlimited set of tags may be defined in XML. As noted above, while HTML tags may be used to display a word in bold or italic, for example, XML provides a framework for tagging structured data. An XML element can declare its associated data to be a price, a tax, a title, or any other desired data. As XML tags are adopted, there will be a corresponding ability to search for and manipulate data regardless of the applications within which it is found. Once data has been located, it can be delivered over a network and presented in a browser in any number of ways, or it can be handed off to other applications for further processing and viewing.

XML is a subset of the Standard Generalized Markup Language (SGML) that is optimized for delivery over the Web. XML provides a data standard that can encode the content, semantics, and schemata for a wide variety of cases ranging from simple to complex, and which may be used to markup the following: an ordinary document; a structured record, such as an appointment book or purchase order; an object with data and methods, such as the persistent form of a Java object; a data record, such as the result set of a query, meta content of a site; graphical presentations; standard schema entities and types; and all links between entities and types. Once the data is on the clien'ts desktop it can be manipulated, edited, and presented in multiple views, without returning to the server. Servers may then become more scalable, due to lower computational and bandwidth loads. Also, because data is exchanged in the XML format, it can be easily merged from different sources. In the illustrated embodiment, the CR product selector file is an XML file. However, CR product selector file 126 may be defined by other file or application types, including a different markup language, such as HTML.

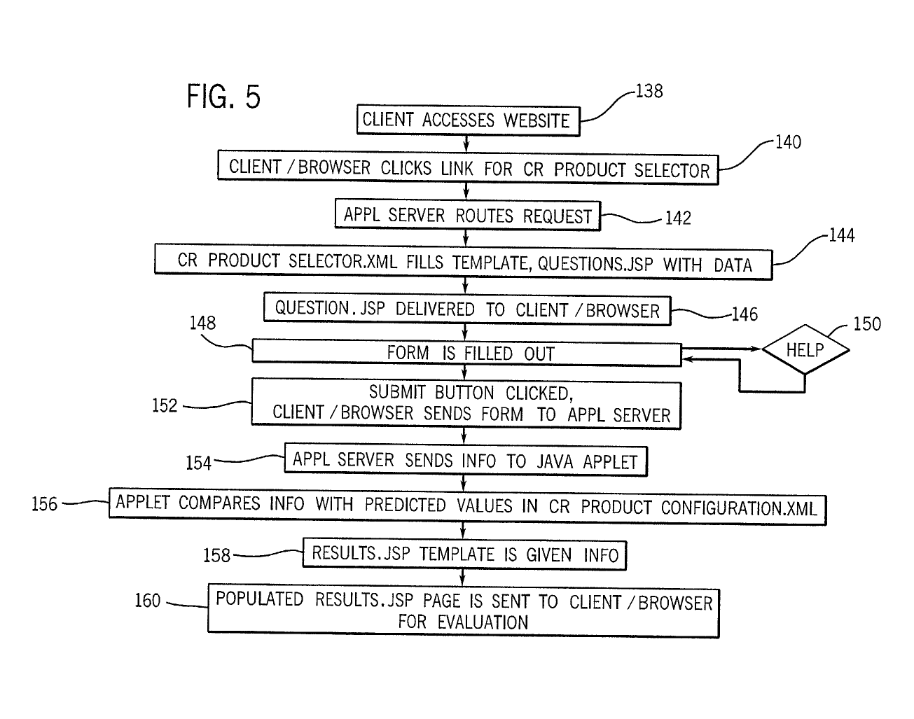

Referring generally to FIG. 5, an exemplary process by which a customer may be provided with a recommended CR system is illustrated. Initially, a customer or client accesses a site, as referenced by step 138. The site may provide a CR system supplier home page, a CR system specification page, a product selector page, or some other page of interest to a customer or client interested in purchasing a suppliers CR systems, CR system components, software, etc. Initially, the client or customer activates a link on the page to enter a CR system product selector, as referenced by step 140. An application server routes the request to enter the CR system product selector to a CR System product selector file, as referenced by step 142. In an exemplary embodiment, the CR product selector file is an XML file. The CR System product selector file contains the data representing the questions to ask a customer to narrow the choice of a CR system, component, or software to a recommended CR system, component, or software. The CR System product selector file fills the query page template with the data, e.g., questions, as referenced by step 144. In an exemplary embodiment, the query page is a Java script file. The query page is sent to the client/customer browser for completion, as referenced by step 146.

The client/customer then completes the query page, as referenced by step 148. If a client/customer would like additional information to help in choosing an answer, the client may activate a link to a help file, as referenced by step 150. When the link is activated, a help page 130 is presented to the customer. In this embodiment, the help page 130 provides additional information specific to each question on the query page. The additional information is designed to assist the client/customer answer the questions. After obtaining the information, the client/customer may then return to the query page and continue answering questions. When the client/customer has completed answering the questions, the completed query page is sent back to the application server by activating a button on the query page, as referenced by step 152.

In the exemplary process, the application server couples the completed query page 128 to a Java applet 132, as referenced by step 154. The Java applet 132 compares the information provided by the client/customer in their answers to the questions in the query page to predicted responses to the questions contained within the product configuration file 134, as referenced by step 156. If a match is found between the customer's response to the questions and the predicted responses to the questions, the results page 136 is filled with data describing the recommended CR system, component, or software, that corresponds to the predicted responses to the questions, as referenced by step 158. The results page 136 is then provided to the client/customer for viewing and/or evaluation, as referenced by step 160.

Referring generally to FIG. 6, a page 162 for a CR system supplier is illustrated. The page 162 may contain information about the suppliers CR systems, components or software. In addition, the page 162 also contains a link 164 to a CR product selector.

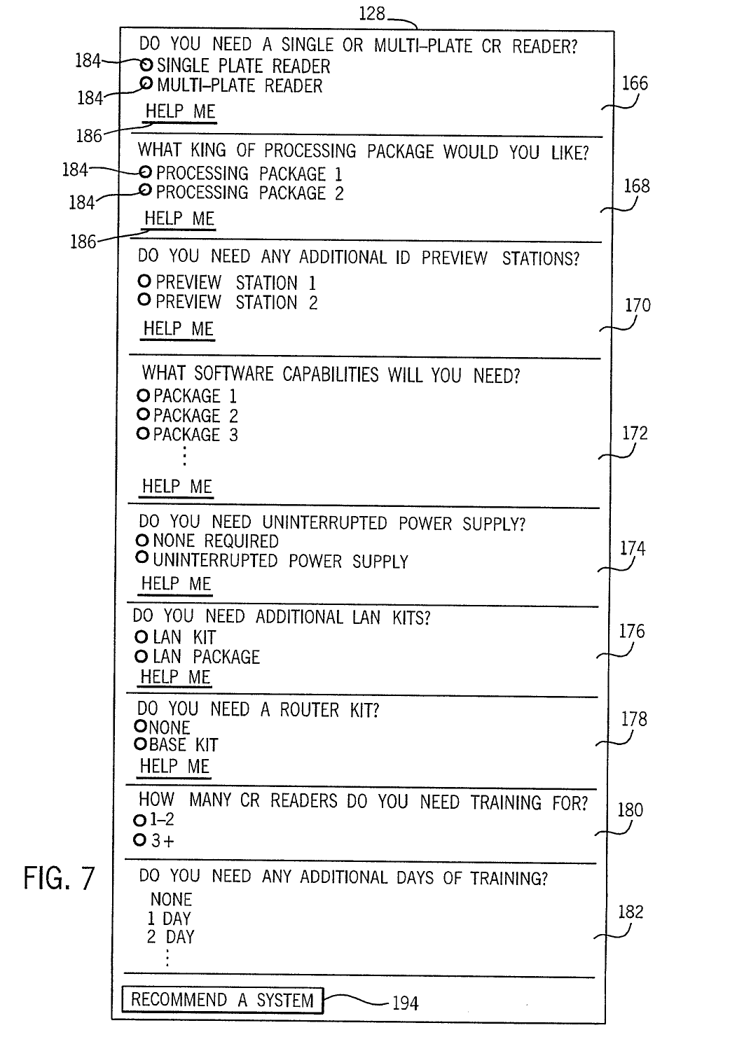

Referring generally to FIG. 7, when the link 164 is activated, system 120 operates to provide the client/customer browser 122 with a query page 128. In the illustrated embodiment, there are a series of multiple-choice questions 166, 168, 170, 172, 174, 176, 178, 180, 182 provided to a client/customer. Each choice is answered by selecting one or more of the choice registers 184. Some questions may have mutually exclusive answers while others may allow multiple answers. The choice registers 184 may be selected by placing the cursor over a choice register 184 and clicking with a mouse button.

The series of questions may be designed to elicit a myriad of customer information to the CR system supplier. For example, the questions may be used to reduce the total number of CR systems provided by a supplier to a single recommended CR system, including components and software. Additionally, or alternatively, the questions may be designed to give a supplier an indication of any equipment, accessories, peripherals or software the client/customer's may require to place a CR system, and associated personnel, in service. For example, in the illustrated embodiment, question 166 narrows the selection of possible CR systems by asking the client/customer to specify a single or multi-plate CR reader.

In addition to the CR systems type selected, question 168 asks which, if any, of two possible processing software packages the client may desire. For example, some image processing software may work on some CR systems and not on others. Question 170 asks whether additional viewing stations may be needed. This information may be useful in selecting a CR system or in ensuring that a client/customer obtains the proper CR system components and software. In the illustrated embodiment, additional questions ask what software packages are desired (question 172), whether an uninterrupted power supply is desired (question 174); whether a LAN kit or LAN package is desired (question 176), whether a router kit is desired (question 178), how many CR system readers may need training (question 180), or if any additional days of training are desired (question 182).

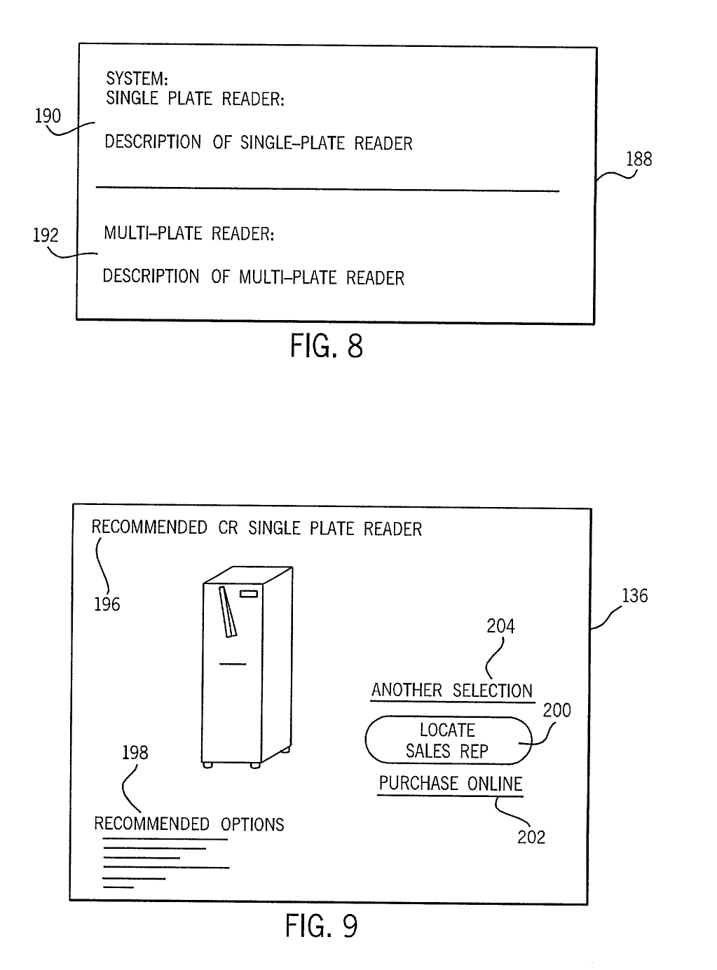

In addition, in this embodiment, each question has a link 186 to the “Help Me” file 130. When the link 186 is activated a small browser window 188 is opened, as best illustrated in FIG. 8. In the illustrated embodiment, the link 186 after the question, “Do you need a single or multi-plate CR reader?” has been activated. Browser window 188 contains text 190 describing a single plate reader and text 192 that describes a multi-plate reader. However, web browser window 188 and “Help Me” file 130 may be populated with any type of information that may be designed to assist 12a client/customer in selecting between a single plate or a multi-plate CR reader, or any of the other questions provided to the client/customer. Referring again to FIG. 7, when the client/customer has made their selections, a virtual button 194 is activated. Activating the virtual button 194 directs the query page to be returned to the system 120 and directs the system 120 to provide the customer with a recommended CR system, component or software.

Referring generally to FIG. 9, system 120 provides the recommendation for a CR system, component, or software on a results page 136. The results page 136 provides the client/customer with a recommended system 196 and recommended options 198. Additionally, results page 136 may have a button 200 that is operable to activate a program to identify a supplier sales representative located near the client/customer. The results page 136 may also have a purchasing link 202 to initiate a purchasing program to enable a client/customer to purchase a CR system, component, or software. The results page 136 may also have a link 204 to enable a client/customer to perform another product selection with the CR product selector.

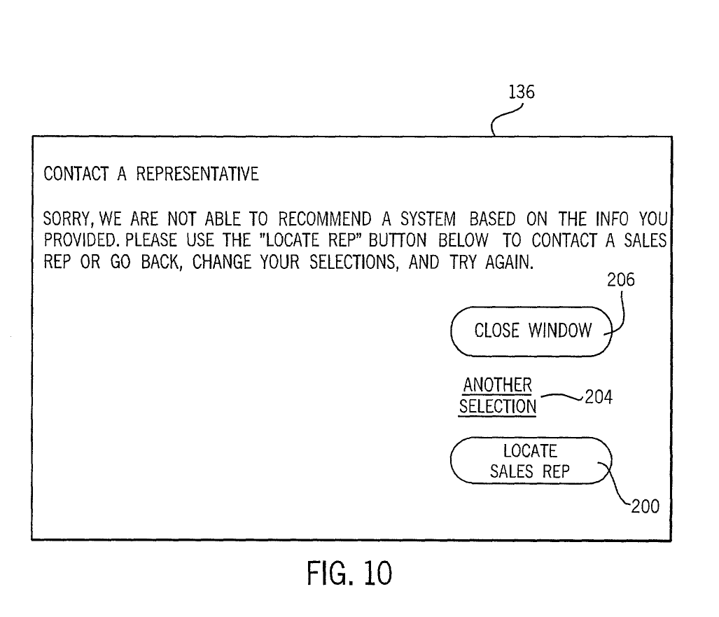

As best illustrated in FIG. 10, if there is no CR system, component, or software that matches the client/customer's responses to the questions the results page 136 may inform the client/customer that no CR system, component, or software may be recommended based on the client/customer's responses to the questions. The client/customer may be informed to contact a CR system supplier's sales representative. Therefore, this embodiment of results page 136 also may have a virtual button 200 that is operable to activate a program to identify the supplier's sales representative nearest to the client/customer. The results page 136 also may have a virtual button 206 to close the browser to close the product selector.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A computer system coupled to a network to enable a computed radiography (CR) system supplier to provide a customer with a recommended CR system from among a plurality of CR systems, the computer system comprising:
an application server to direct a query page to the customer via the network, wherein the query page comprises a plurality of questions designed to enable the computer system to determine a recommended CR system based on the customer's responses to the plurality of questions, wherein at least one question establishes whether a single plate CR system or a multiple plate CR system is to be recommended;
a comparison program to receive a completed query page from the customer and compare the customer's responses in the completed query page to information stored in the computer system to determine the recommended CR system; and
a server to provide a results page to the customer via the network, the results page providing the customer with a recommended single plate or multiple plate CR system.

2. The system as recited in claim 1, wherein the application server comprises a Java class.

3. The system as recited in claim 1, wherein the comparison program comprises a Java applet.

4. The system as recited in claim 1, further comprising a product selector file, wherein the product selector file contains the plurality of questions for supplying the query page.

5. The system as recited in claim 4, wherein the product selector file is written in extensible markup language (XML).

6. The system as recited in claim 1, wherein the query page is written in Java script.

7. The system as recited in claim 1, wherein the query page comprises a link to a help page, wherein the help page provides information to assist a customer answer at least one of the plurality of questions.

8. The system as recited in claim 1, wherein each question has an associated link to a help page, wherein the help page provides information to assist a customer answer each of the plurality of questions.

9. The system as recited in claim 1, wherein the information stored in the computer system is stored in a product configuration file, wherein the product configuration file contains data on specific configurations of CR systems.

10. The system as recited in claim 9, wherein the specific configurations of CR systems is determined by a sales history of specific configurations of CR systems.

11. The system as recited in claim 9, wherein a specific configuration of a CR system comprises software packages.

12. The system as recited in claim 9, wherein the product selector file is written in extensible markup language (XML).

13. The system as recited in claim 9, wherein the product selector file populates the results page with a specific CR system configuration that matches the customer's responses in the completed query page.

14. The system as recited in claim 1, wherein the results page is written in Java script.

15. A computer system coupled to a network to assist a customer to select a computed radiography (CR) system from among a plurality of CR systems, the computer system comprising:
an application server coupled to a network, the application server directing a customer to files stored in the computer system;
a product selector file written in a markup language and stored in the computer system, the product selector file defining a plurality of questions designed to elicit data from a customer to determine a computed radiography system to recommend to the customer from among a plurality of CR systems, wherein the product selector file provides the plurality of questions to a query page for delivery to a customer;
a program that operates to determine a recommended CR system for the customer by comparing data provided by the customer via the plurality of questions to CR system data stored in the computer system; and
a product configuration file written in a markup language and stored in the computer system, the product configuration file holding the CR system data used by the program, wherein the product configuration file provides information relating to a recommended CR system to a results page for delivery to the customer.

16. The system as recited in claim 15, wherein the product selector file is written in extensible markup language (XML).

17. The system as recited in claim 15, wherein the product configuration file is written in extensible markup language (XML).

18. The system as recited in claim 15, wherein each question is a multiple-choice question.

19. The system as recited in claim 18, further comprising a help file written in a markup language and containing information regarding each choice in at least one multiple-choice question.

20. The system as recited in claim 19, wherein the help file is written in hypertext markup language (HTML).

21. The system as recited in claim 15, wherein the application server is a Java class.

22. The system as recited in claim 15, wherein the program is a Java applet.

23. The system as recited in claim 15, wherein the query page is written in a Java script language.

24. The system as recited in claim 15, wherein the results page is written in a Java script language.

25. The system as recited in claim 15, wherein a recommended computer system comprises software.

26. A method of utilizing a computer system coupled to a network to assist a customer to configure a computed radiography (CR) system from among a plurality of CR systems, components and software, the method comprising the acts of:
routing a request for assistance from a customer to a product selector file written in extensible markup language (XML), wherein the product selector file fills a template with questions stored in the product selector file;
delivering the template over the network to a customer;
receiving a completed template from the customer; and
determining a recommended CR system configuration by comparing customer data derived from the completed template to supplier data stored in the computer system in a product configuration file written in XML, wherein the product configuration file fills a results page with the recommended CR system configuration for delivery to the customer over the network.

27. The method as recited in claim 26, wherein routing comprises activating a link in a page to an application server.

28. The method as recited in claim 27, wherein the application server routes the request to the product selector file.

29. The method as recited in claim 27, wherein the template is a Java script file.

30. The method as recited in claim 27, wherein the results page is a Java script file.

31. A method of utilizing a computer system to configure a recommended computed radiography (CR) system from among a plurality of CR systems, components and software, the method comprising the acts of:
connecting a customer communication system to a computer system provided by a CR system supplier;
routing a request for assistance from the customer to a product selector file written in extensible markup language (XML), wherein the product selector file fills a template with questions stored in the product selector file;
delivering the template to a customer;
completing the template with the customer communication system and transmitting it to the computer system;
receiving a completed template from the customer; and
determining a recommended CR system and configuration by comparing customer data derived from the completed template to supplier data stored in the computer system in a product configuration file written in XML, wherein the product configuration file fills a results page with the recommended CR system configuration for delivery to the customer communication system.

32. The method as recited in claim 31, wherein the customer communication system is a second computer system having an interface coupled to the Internet.

33. The method as recited in claim 32, wherein the supplier data comprises data for a plurality of CR system configurations of components and software.

34. The method as recited in claim 33, wherein determining comprises using a program to compare the customer data to the plurality of CR system configurations of components and software.

35. The method as recited in claim as recited in claim 34, wherein the product configuration file provides the results page with the data for a specific CR system configuration of components and software when the program identifies a specific CR system configuration that matches the customer data.
